(19) United States
(12) Patent Application Publication
(10) Pub. No.: US 2025/0317676 A1
(43) Pub. Date: Oct. 9, 2025

(54) SHAFT HOLDING STRUCTURE

(71) Applicant: Audio-Technica Corporation, Tokyo (JP)

(72) Inventor: Takashi MURATA, Tokyo (JP)

(21) Appl. No.: 19/094,002

(22) Filed: Mar. 28, 2025

(30) Foreign Application Priority Data
Apr. 9, 2024 (JP) 2024-062706

(51) Int. Cl. H04R 1/08; H04M 1/05

(52) U.S. Cl. CPC H04R 1/08; H04M 1/05

(57) ABSTRACT

A shaft holding structure includes: a microphone support member that supports a microphone unit, and also has a rod-shaped shaft at part thereof; and a holding member having formed therein a shaft holding section that holds the shaft in a state where the shaft is movable in an extending direction of the shaft, in which the shaft holding section has: a peripheral wall that has a first inner circumferential surface formed in an arc-like shape, and receives the shaft; and a raised section forming a second inner circumferential surface that is formed to protrude from the first inner circumferential surface, and has a radius of curvature greater than a radius of curvature of the first inner circumferential surface, and an outer circumferential surface of the shaft abuts on the second inner circumferential surface in an assembled state where the shaft is received by the shaft holding section.

### CROSS-REFERENCE TO RELATED APPLICATIONS

The present application claims priority to Japanese Patent Application No. 2024-62706, filed on Apr. 9, 2024, contents of which are incorporated herein by reference in their entirety.

### BACKGROUND OF THE INVENTION

The present invention relates to a shaft holding structure. There have been conventionally-known headset-type acoustic devices having a headband to be worn on the head of a user, and a sound collecting microphone (e.g. see Japanese Patent Application Publication No. H11-331970). The sound collecting microphone is fixed to an arm member, and the arm member is held by a predetermined holding member.

In order to finely adjust the position of a microphone in a configuration like the one mentioned above, an arm member may be provided such that the position of the arm member is rotatable or is movable in the extending direction of the arm. However, in the case of such a configuration, there is a problem that, if positional adjustments of the arm member are repeated, the sense of friction between the arm member and a holding member holding becomes gradually lower.

### BRIEF SUMMARY OF THE INVENTION

Therefore, the present disclosure has been made in view of these matters, and an object thereof is to provide a shaft holding structure that makes it unlikely for the sense of friction at the time of the movement of a support member supporting a microphone to lower.

A shaft holding structure according to one form of the present disclosure includes: a microphone support member that supports a microphone unit, and also has a rod-shaped shaft at part thereof; and a holding member having formed therein a shaft holding section that holds the shaft in a state where the shaft is rotatable about a central axis of the shaft or the shaft is movable in an extending direction of the shaft, in which the shaft holding section has: a peripheral wall that has a first inner circumferential surface formed in an arc-like shape as seen in a cross-section orthogonal to the extending direction of the shaft, and receives the shaft; and a raised section forming a second inner circumferential surface that is formed to protrude from the first inner circumferential surface, and has a radius of curvature greater than a radius of curvature of the first inner circumferential surface, and an outer circumferential surface of the shaft abuts on the second inner circumferential surface of the raised section in an assembled state where the shaft is received by the shaft holding section.

### BRIEF DESCRIPTION OF THE DRAWINGS

FIG. 1 is a perspective view of a microphone apparatus.

FIG. 2A is a figure depicting the microphone apparatus.

FIG. 2B is a figure depicting the microphone apparatus.

FIG. 3 is a side view of the microphone apparatus.

FIG. 4 is a perspective view of a left contact pad section.

FIG. 5 is an exploded perspective view of the left contact pad section.

FIG. 6 is an exploded perspective view depicting a microphone support member and a base member.

FIG. 7 is an exploded perspective view depicting the configurations of the microphone support member and the left contact pad section.

FIG. 8 is a cross-sectional view depicting a locking mechanism and a surrounding structure thereof.

FIG. 9 is a perspective view of a slider member and an urging member.

FIG. 10 is a perspective view depicting the inner side of a shaft holding section of a cover member.

FIG. 11 is a figure depicting the cover member as seen from its inner side.

FIG. 12 is a schematic diagram depicting the shape of the shaft holding section in a cross-section orthogonal to the shaft of the microphone support member.

FIG. 13A is a figure for explaining the positional relationship between a raised section and the shaft in the assembled state.

FIG. 13B is a figure for explaining the positional relationship between the raised section and the shaft in the assembled state.

FIG. 14 is a figure schematically depicting a cross-sectional shape of the raised section taken along a line A-A in FIG. 11.

### DETAILED DESCRIPTION OF THE INVENTION

Hereinafter, the present disclosure will be described through exemplary embodiments, but the following exemplary embodiments do not limit the disclosure according to the claims, and not all combinations of features described in the exemplary embodiments are necessarily essential to the disclosure.

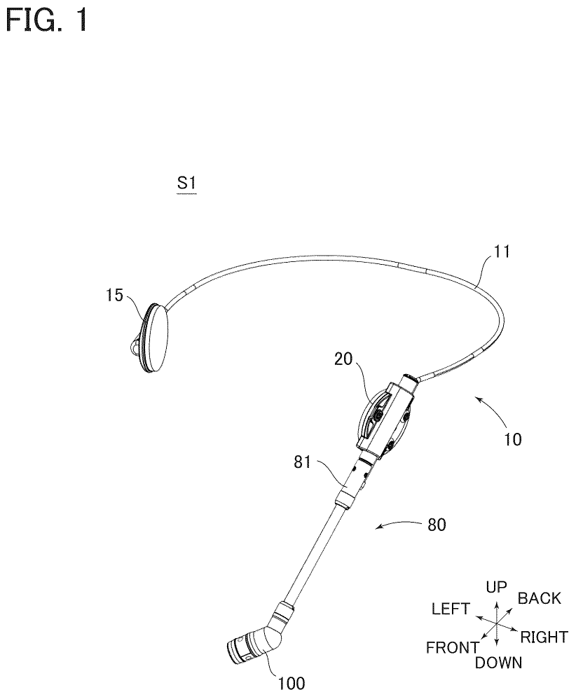

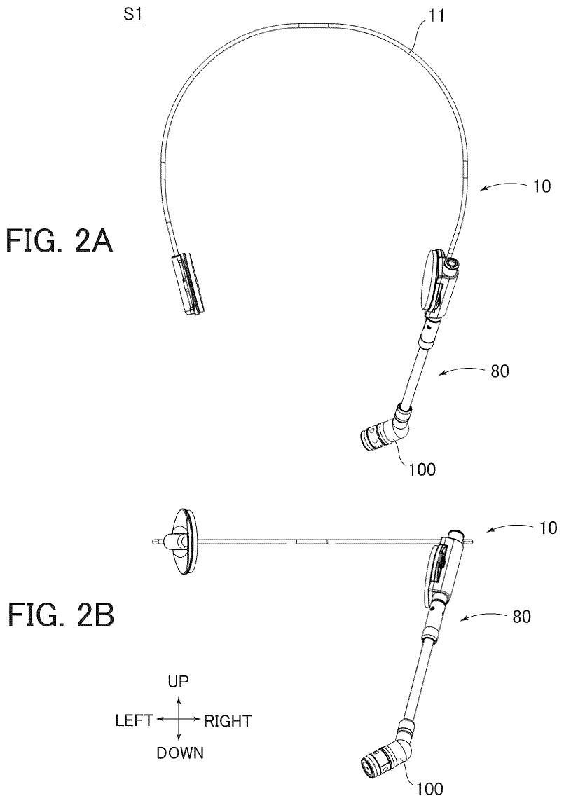

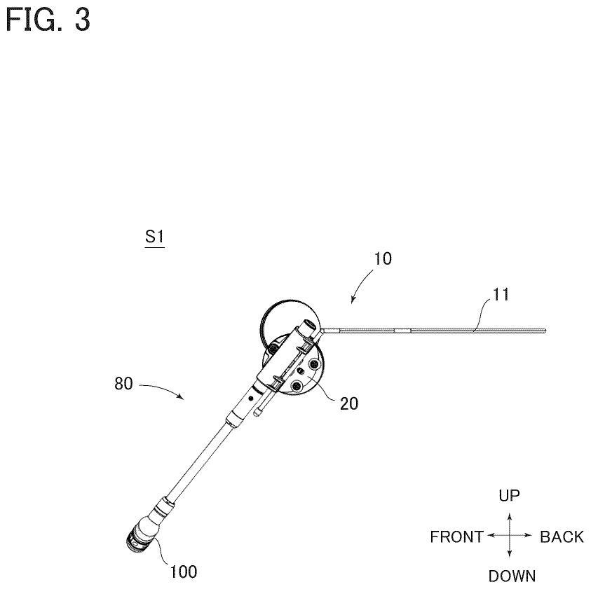

FIG. 1 is a perspective view of a microphone apparatus. FIG. 2A and FIG. 2B are figures depicting the microphone apparatus. FIG. 2A is a plan view, and FIG. 2B is a front view. FIG. 3 is a side view of the microphone apparatus.

As depicted in FIG. 1, a microphone apparatus S1 includes a headband unit 10 and a microphone section 80.

The headband unit 10 is a portion to be worn on the head of a user. The headband unit 10 has a head wire 11, a right contact pad section 15, and a left contact pad section 20.

The head wire 11 is an elastic wire formed in an approximately arc-like shape. In the microphone apparatus S1 of the present embodiment, the head wire 11 is provided in such an orientation that the head wire 11 extends from a side of the head of the user along the back of the head in a state where the microphone apparatus S1 is being worn on the head of the user. Note that the configuration of the present disclosure is not limited to such a configuration, but may be a configuration in which the head wire 11 is arranged in such an orientation that the head wire 11 extends from a side of the head to the top of the head.

The right contact pad section 15 is provided at one end of the head wire 11. The right contact pad section 15 has a flat shape. The right contact pad section 15 is a portion that abuts on the right side of the head of the head of the user.

The left contact pad section 20 is provided at the other end of the head wire 11. Similarly to the right contact pad section 15, the left contact pad section 20 also has a flat shape. The left contact pad section 20 is a portion that abuts on the left side of the head of the head of the user. The left contact pad section 20 supports the microphone section 80.

As depicted in FIG. 1, the microphone section 80 has a microphone support member 81 and a microphone unit 100. Whereas the microphone section 80 is supported by the left contact pad section 20 in the present embodiment, the microphone section 80 may be supported by the right contact pad section 15.

The microphone support member 81 is formed to extend from the headband unit 10. The microphone support member 81 has a round rod shape, as an example. The microphone support member 81 has a portion formed using a flexible member which can be deformed such that the orientation of the microphone can be changed. Specifically, the microphone support member 81 is supported by the left contact pad section 20 in such an orientation that the microphone support member 81 extends from the headband unit 10 toward the mouth of the user in a state where the microphone apparatus S1 is being worn by the user.

The microphone unit 100 is provided to the microphone support member 81. The microphone unit 100 may be provided at any position of the microphone support member 81, and, in this example, is provided at an end of the microphone support member 81.

### Shaft Position Adjustment Mechanism

The left contact pad section 20 of the microphone apparatus S1 is provided with: a shaft position adjustment mechanism for adjusting the position of the microphone support member 81; and a shaft holding mechanism for maintaining the sense of friction of the movement of the microphone support member 81 (details thereof are mentioned later). Although the shaft position adjustment mechanism is not an essential configuration of the present disclosure, hereinbelow, explanation of the shaft position adjustment mechanism is given, and thereafter the shaft holding mechanism according to one form of the present disclosure is explained.

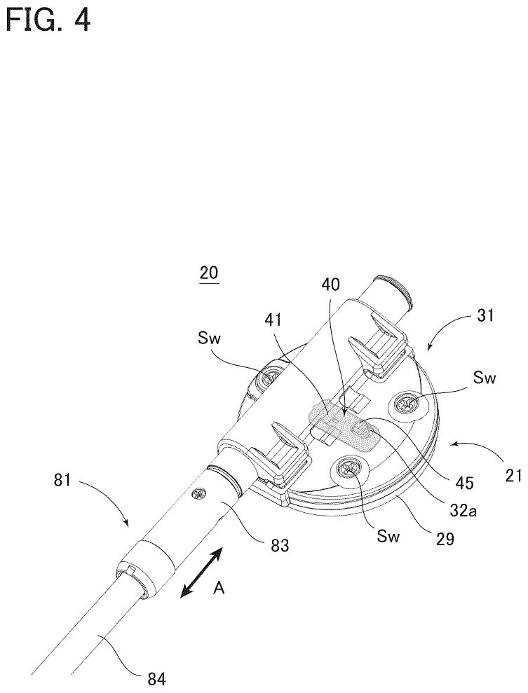

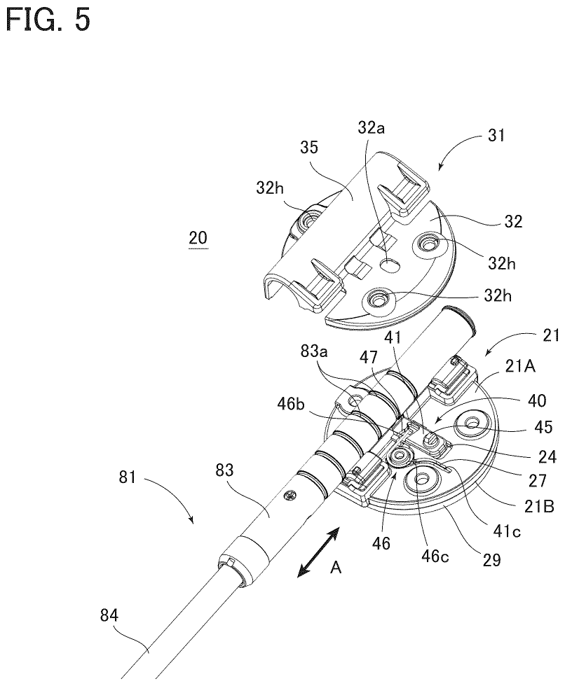

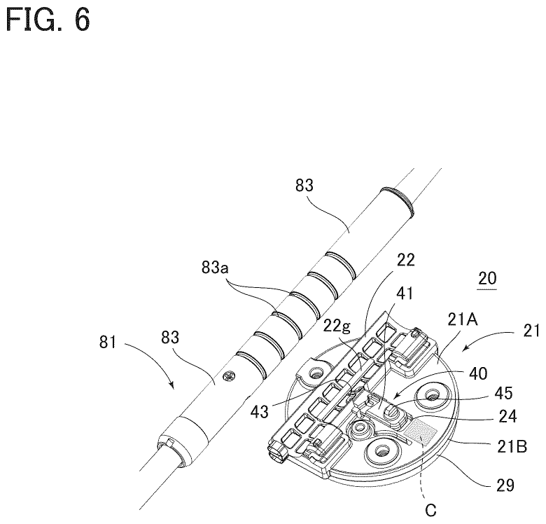

FIG. 4 is a perspective view of the left contact pad section. In FIG. 4, a state where a slider member arranged inside the cover member is seen through the cover member is drawn. FIG. 5 is an exploded perspective view of the left contact pad section. FIG. 6 is an exploded perspective view depicting the microphone support member and a base member.

In the microphone apparatus S1 of the present embodiment, the microphone support member 81 is configured such that the position of the microphone support member 81 relative to the left contact pad section 20 can be adjusted in a direction represented by an arrow A in FIG. 4. Specifically, the microphone support member 81 is configured such that the protruding length of the microphone support member 81 from the left contact pad section 20 can be changed. The shaft position adjustment mechanism for adjusting the position of the microphone support member 81 in this manner is explained hereinbelow.

As depicted in FIG. 4 and FIG. 5, the shaft position adjustment mechanism has the microphone support member 81, a base member 21, a cover member 31, and a locking mechanism 40. Note that the shaft position adjustment mechanism need not include only the elements described above, but may include other elements.

Whereas the microphone support member 81 is the round-rod-shaped member as mentioned above, specifically, the microphone support member 81 has a shaft 83 and a microphone arm 84. As depicted in FIG. 5, the shaft 83 has a round rod shape, and has, on its outer circumferential surface, a plurality of grooves 83a (see FIG. 5) that are formed at predetermined intervals. The intervals between the grooves 83a may be uniform or may be not uniform. The shaft 83 is made of metal, as an example.

The microphone arm 84 is a round-rod-shaped flexible arm, and is connected to the shaft 83. The microphone unit 100 mentioned above is attached to the leading end of the microphone arm 84.

The base member 21 and the cover member 31 form a holding member in the present disclosure. When the base member 21 and the cover member 31 are coupled with each other, the base member 21 and the cover member 31 hold the shaft 83 of the microphone support member 81 in a state where the shaft is movable in its extending direction. The materials of the base member 21 and the cover member 31 can be any materials, and, in the present embodiment, are made of resin, for example.

The base member 21 is a member formed in a flat disk shape. The base member 21 has a first surface 21A and a second surface 21B. The second surface 21B is a surface that faces a side of the head of the user when the microphone apparatus S1 is being worn on the head of the user. The second surface 21B is provided with a sheet elastic body 29 for enhancing wearability.

The first surface 21A is a surface opposite to the second surface 21B. As depicted in FIG. 6, the first surface 21A has formed thereon a receiving section 22 that receives part of the shaft 83. Specifically, the receiving section 22 has a recessed shape that receives an approximately half area of the outer circumference of the shaft 83. The receiving section 22 has a guide rib 22g formed therein.

The guide rib 22g is a linear rib, and extends along the extending direction of the shaft 83. The guide rib 22g has a function to prevent the rotation of the shaft 83 about its central axis, and also to guide the movement of the shaft 83 in its extending direction. In addition, the guide rib 22g has a function to make the shaft 83 positioned at a predetermined position in a shaft holding section 35 when in the assembled state. The guide rib 22g regulates the position of the shaft 83 so as to prevent the shaft 83 from moving even if the shaft 83 is pressed from side by a slider member 41.

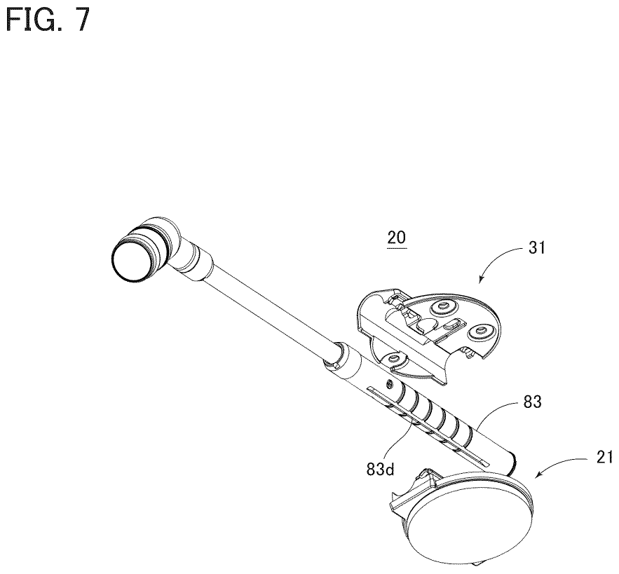

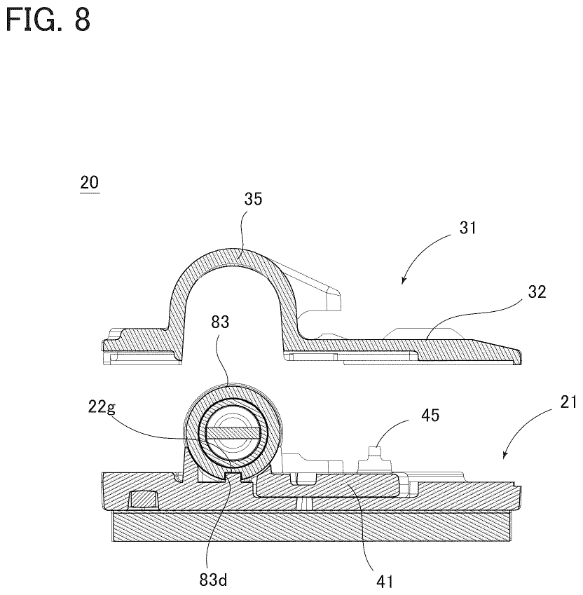

FIG. 7 is an exploded perspective view depicting the configurations of the microphone support member and the left contact pad section. FIG. 8 is a cross-sectional view depicting the locking mechanism and a surrounding structure thereof. As depicted in FIG. 7, the shaft 83 has a guide groove 83d formed to extend in the extending direction of the shaft 83. The guide groove 83d is a linearly-formed groove. The guide rib 22g is inserted into the guide groove 83d (FIG. 8).

The cover member 31 is a member fixed to the base member 21. Specifically, the cover member 31 is fixed to the base member 21 in a state where the shaft 83 of the microphone support member 81 is arranged between the base member 21 and the cover member 31. The cover member 31 has a cover body 32 and the shaft holding section 35.

As depicted in FIG. 5, in this example, the cover body 32 has an approximately-circular outline shape corresponding to the outline shape of the base member 21. The cover body 32 has a plurality of screw holes 32h formed therethrough. The screw holes 32h extend in the thickness direction of the cover body 32.

Fixation screws Sw (FIG. 4) are inserted to the screw holes 32h. The fixation screws Sw are inserted to the base member 21 in the thickness direction of the base member 21, and screwed into the base member 21. Whereas the fixation screws Sw are illustrated as an example in the present embodiment, fixation members that fix the cover member 31 to the base member 21 are not limited to the fixation screws, but may be fixation pins or the like. Fixation members preferably are, in one form, ones that are inserted in the thickness direction of the base member 21 so as to be able to favorably hold the shaft 83 with the cover member 31 and the base member 21. Thereby, the shaft 83 is sandwiched between the base member 21 and the cover member 31, and is held thereby favorably in a state where the fixation members are fastened.

Note that, other than fixation screws or fixation pins, for example, claws extending from the cover member 31 toward the base member 21 may engage with part of the base member 21, and thereby the cover member 31 may be coupled to the base member 21.

The cover body 32 has an opening 32a formed therethrough as depicted in FIG. 4 and FIG. 5. The opening 32a is a portion that makes a finger hook section (details are mentioned later) of the slider member of the locking mechanism mentioned later exposed therethrough. As an example, the opening 32a is formed to be relatively small in size relative to the overall area size of the cover body 32 when the cover body 32 is seen in its thickness direction. The area size of the opening 32a is, but is not limited to be, equal to or lower than ⅕ of the area size of an area formed by projecting the cover body 32 in the thickness direction (the inner area size of an area surrounded by the outline of the cover body 32). The position of the shaft 83 is not necessarily changed frequently. However, in a case where the opening 32a and the finger hook section therein are formed large, there is a possibility that a user touches them by an error undesirably, and the position of the microphone support member 81 is unintentionally changed undesirably. In contrast, according to the configuration of the present embodiment, the position of the microphone support member 81 is unlikely to be changed unintentionally in such a manner since the opening 32a and the finger hook section therein are formed relatively small. Note that the opening 32a being formed relatively small in this manner is merely an example, and the opening 32a may be formed large such that its size exceeds ⅕ of the area size of an area formed by projecting the cover body 32 in the thickness direction.

The shaft holding section 35 is a portion that holds the shaft 83 of the microphone support member 81. The shaft holding section 35 is formed in a shape protruding from the cover body 32 in the thickness direction of the cover body 32 (a shape protruding in a direction away from the cover body 32). A structure for maintaining the sense of friction of the movement of the microphone support member 81 even in a case where the microphone apparatus S1 is used for a long term, and positional adjustments of the microphone support member 81 are performed repeatedly is provided inside the shaft holding section 35. This is mentioned later with reference to other figures.

### Locking Mechanism

The locking mechanism 40 is a mechanism for fixing the position of the shaft 83 of the microphone support member 81 at the shaft holding section 35. As depicted in FIG. 5, the locking mechanism 40 has the slider member 41 and an urging member 46.

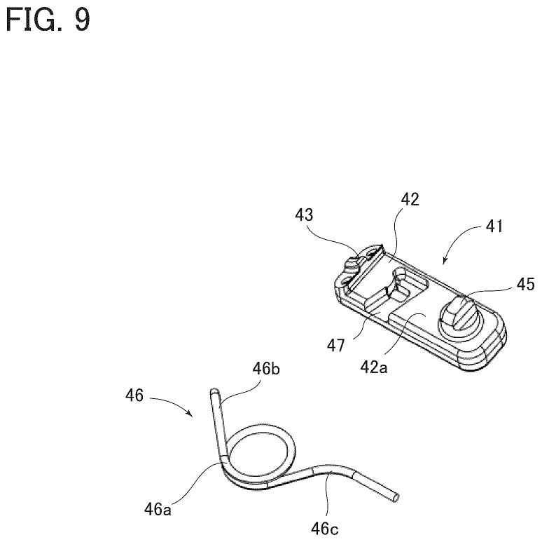

FIG. 9 is a perspective view of the slider member and the urging member. The slider member 41 has a thin tabular shape. Specifically, the slider member 41 has a body section 42, a claw 43, a finger hook section 45, and a spring receiving section 47.

The claw 43 is a portion that fits into one of the plurality of grooves 83a (FIG. 5, FIG. 6) of the shaft 83. As an example, the claw 43 has a width which is approximately the same as the width of the grooves 83a. The claw 43 is formed to protrude from the body section 42.

The finger hook section 45 is formed to protrude from a top surface 42a of the body section 42. As mentioned later, the finger hook section 45 is a portion to be operated by a user in order to move the slider member 41 to a position where the claw 43 comes off from the groove 83a. For example, the finger hook section 45 may be formed in such a shape that the finger hook section 45 does not or does protrude from the top surface of the cover member 31 (a surface opposite to the base member) in a state where the cover member 31 is attached to the base member 21.

The spring receiving section 47 (FIG. 9) is a portion that receives part of the urging member 46 as mentioned later. The spring receiving section 47 is formed in a recessed shape by being carved in from the top surface 42a in the thickness direction of the slider member 41. That is, the spring receiving section 47 is a recess concave from the outer surface of a slide member 47 in the thickness direction of the slide member 47. According to such a configuration, members can be reduced in size as compared with a configuration in which a protrusion that receives a spring is formed on the top surface 42a.

As an example, in the present embodiment, the urging member 46 is a torsion spring. Specifically, the urging member 46 has a winding section 46a, a first arm 46b, and a second arm 46c.

FIG. 5 and FIG. 6 are referred to again. The slider member 41 is arranged in a guide recess 24 formed on the base member 21. The guide recess 24 is a groove formed to extend in a direction orthogonal to the extending direction of the shaft 83. Inside the guide recess 24, the slider member 41 is provided to be movable in directions to move toward and move away from the shaft 83.

The urging member 46 is arranged in a spring receiving section 27 formed at the base member 21. The spring receiving section 27 is a recess formed by being carved in from the first surface 21A. The urging member 46 is a member that presses the slider member 41 toward the shaft 83. Specifically, the urging member 46 is provided on the base member 21 in such an orientation that the extending direction of the central axis of the winding section 46a (FIG. 9) becomes parallel to the thickness direction of the base member 21. Specifically, the second arm 46c of the urging member 46 is contained in the spring receiving section 27. On the other hand, the first arm 46b of the urging member 46 extends out from the inside of the spring receiving section 27, and has a leading end that has fit into the spring receiving section 47 of the slider member 41.

In the state depicted in FIG. 5, the first arm 46b is pressing the slider member 41 toward the shaft 83 by the elastic force of the urging member 46. Due to the slider member 41 being pressed toward the shaft 83, the claw 43 (FIG. 6) fits into the groove 83a of the shaft 83, and thereby the position of the shaft 83 is fixed. In order to unlock, it is sufficient if a user operates the finger hook section 45, and move the slider member 41 to a position where the claw 43 comes off from the groove 83a.

As the urging member 46, for example, an expandable/contractible coil spring may be used. However, in a case where a coil spring is arranged in a structural section with a relatively small size like the left contact pad section 20 of the present embodiment, there is a fear that the size of the left contact pad section 20 increases. For example, in the case of a configuration in which a coil spring is arranged in an area C in FIG. 6, there is a fear that it becomes necessary to increase the diameter of the left contact pad section 20 in order to ensure a sufficient length of the coil spring.

In this regard, in a case where the urging member 46 is a torsion spring, as depicted in FIG. 5, the urging member 46 and its surrounding structure can be configured compactly. In particular, in the present embodiment, since the first arm 46b is arranged to be contained inside the spring receiving section 47 of the slider member 41, for example, it becomes possible to reduce the thickness of the left contact pad section 20 as compared with a structure in which a spring hook section formed to protrude from the top surface 42a hooks the first arm 46b.

### Advantages of Shaft Position Adjustment Mechanism of Microphone Apparatus S1

The shaft position adjustment mechanism of the microphone apparatus S1 mentioned above is provided with the slider member 41 and the urging member 46 as the locking mechanism 40. A user can unlock, and adjust the position of the shaft 83 by operating the finger hook section 45 of the slider member 41 to slide the slider member 41. According to such a configuration, it is possible to adjust the position of the microphone support member 81 by simple operation as compared with a configuration that requires, for example, loosening a predetermined screw or removing the cover member 31 in order to adjust the position of the shaft 83.

In addition, in a case where the urging member 46 is a torsion spring, there is the advantage that the locking mechanism 40 can be configured in a small size easily as compared with a case where a coil spring is used.

In addition, according to the configuration in which the guide rib 22g prevents the shaft 83 from rotating, and also guides the moving direction of the shaft 83, it becomes possible to position the shaft 83 at a predetermined position in the shaft holding section 35 even in a configuration in which urging force from the urging member 46 is applied to the shaft 83 as in the present embodiment. That is, the shaft 83 is prevented from being positioned at an offset position in the shaft holding section 35.

In addition, according to the configuration in which the finger hook section 45 is positioned in the opening 32a of the cover member 31, a user is prevented from unintentionally touching the finger hook section 45 undesirably, and this prevents the lock from being unlocked by an error, and prevents the position of the shaft 83 from shifting.

### Shaft Holding Structure

As mentioned above, in the microphone apparatus S1 of the present embodiment, the microphone support member 81 is configured to be capable of sliding in the extending direction of the shaft 83. It is expected that, in a configuration like the shaft holding section 35 that is an approximately tubular structure, and holds the round-rod-shaped shaft 83, a portion inside the shaft holding section 35 where the shaft 83 slides wears. As a result, there can be a problem that the sense of friction of the movement of the shaft 83 becomes gradually lower. In addition, in this case, there is also a fear that the microphone support member 81 is no longer held stably.

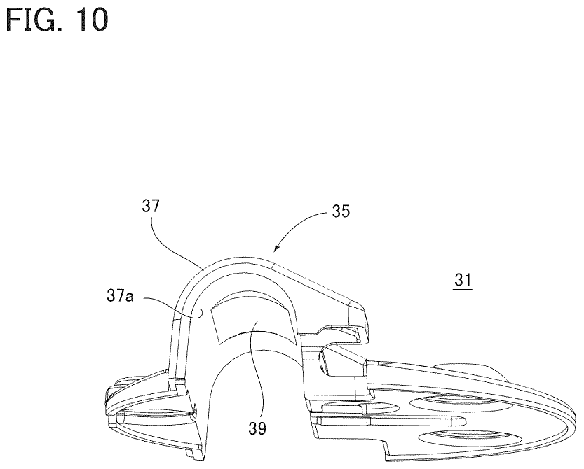

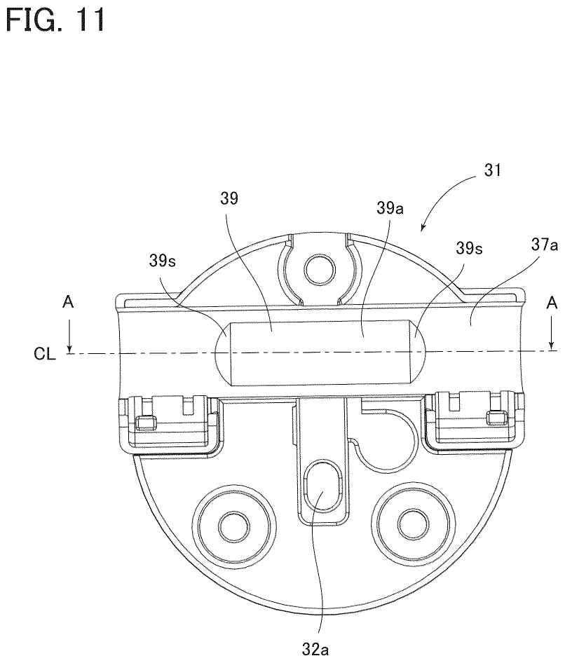

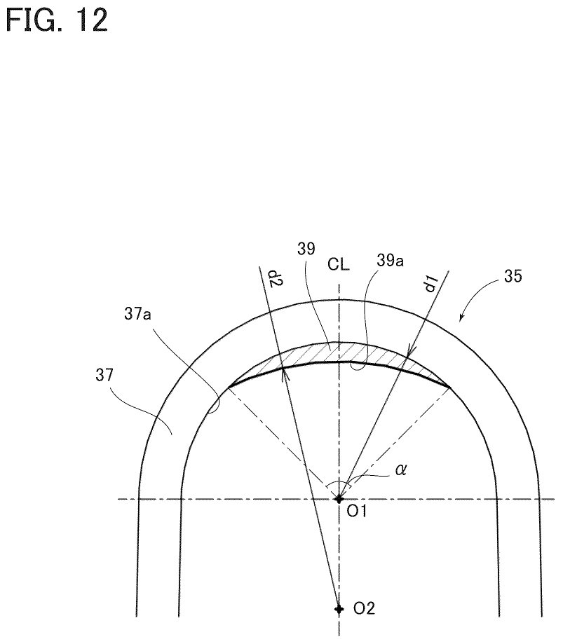

In view of this, a shaft holding structure like the one below is provided in the present embodiment. FIG. 10 is a perspective view depicting the inner side of the shaft holding section of the cover member. FIG. 11 is a figure depicting the cover member as seen from its inner side. FIG. 12 is a schematic diagram depicting the shape of the shaft holding section in a cross-section orthogonal to the shaft of the microphone support member.

As depicted in FIG. 10, the shaft holding section 35 of the cover member 31 has a peripheral wall 37 and a raised section 39.

The peripheral wall 37 is a portion that receives the shaft 83 of the microphone support member 81. A first inner circumferential surface 37a is formed on the inner side of the peripheral wall 37. As depicted in the cross-section in FIG. 12, the first inner circumferential surface 37a includes a portion formed in an arc-like shape. The first inner circumferential surface 37a is U-shaped as seen in the cross-section. The first inner circumferential surface 37a has a radius of curvature d1. The radius of curvature d1 is equal to the radius of the shaft 83 or is slightly greater than the radius of the shaft 83.

As depicted in FIG. 10 and FIG. 12, the raised section 39 is a portion formed to protrude radially inward from the first inner circumferential surface 37a. The raised section 39 includes a second inner circumferential surface 39a having a radius of curvature d2. The radius of curvature d2 is greater than the radius of curvature d1 of the first inner circumferential surface 37a. The raised section 39 has a center O2 (the base point of the radius of curvature) of a circle corresponding to the arc of the raised section 39, the center O2 being positioned on a centerline CL passing through a center O1 (the base point of the radius of curvature) of a circle corresponding to the arc of the first inner circumferential surface 37a, the center O2 being offset from the center O1 toward a side farther from the raised section 39. The centerline CL is a line extending to link the center O1 and the circumferential center of the first inner circumferential surface 37a. In the present embodiment, the radius of curvature d2 is greater than both the radius of the shaft 83 and the radius of curvature d1 of the first inner circumferential surface 37a. As depicted in FIG. 12, the range in which the raised section 39 is formed is a range corresponding to the arc of a sector having a central angle α with respect to the center O1. For example, the angle α is any angle within the range of 60° to 120° inclusive (30° to 60° inclusive on both sides of the centerline CL). By forming the raised section 39 in such a range, it becomes possible for the raised section 39 to exhibit its function favorably.

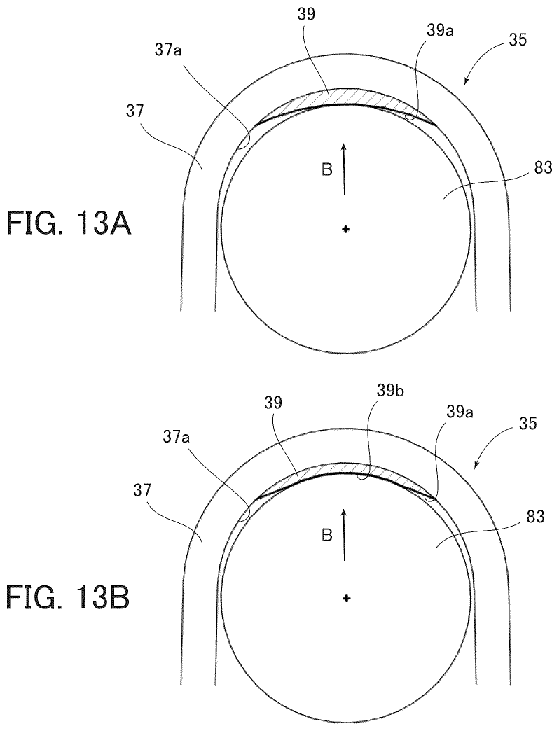

FIG. 13A and FIG. 13B are figures for explaining the positional relationship between the raised section and the shaft in the assembled state. As depicted in FIG. 13A, in the assembled state where the shaft 83 is received by the shaft holding section 35, the outer circumferential surface of the shaft 83 abuts on the second inner circumferential surface 39a of the raised section 39. Specifically, as mentioned before, since the cover member 31 is fixed to the base member 21 with the fixation screws Sw, the cover member 31 is pressed toward the base member 21, and the shaft 83 is pressed against the second inner circumferential surface 39a (see an arrow B; a point contact as seen in a cross-section in the initial state, as an example).

If the microphone apparatus S1 is used for a long term, and positional adjustments of the shaft 83 are repeated, as depicted in FIG. 13B, an area 39b (a portion in contact with the shaft 83) which is part of the raised section 39 gradually wears, and becomes concave in a shape corresponding to the external shape of the shaft 83. Although the raised section 39 wears out in this manner, the area size of contact between the raised section 39 and the shaft 83 increases gradually. With such a configuration, even in a case where positional adjustments of the shaft 83 are repeated, it is possible to prevent the sense of friction at the time of the movement of the shaft 83 from lowering in the shaft holding structure of the present configuration.

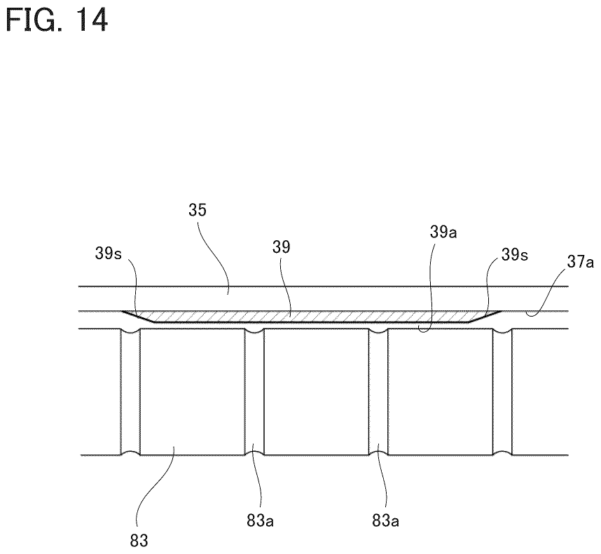

FIG. 11 and FIG. 14 are referred to. FIG. 14 is a figure schematically depicting a cross-sectional shape of the raised section taken along a line A-A in FIG. 11. The raised section 39 is formed at part of the first inner circumferential surface 37a in its lengthwise direction. As depicted in FIG. 11, the raised section 39 is not formed over the entire first inner circumferential surface 37a, but is formed in a partial area thereof in the present embodiment. Specifically, as an example, the raised section 39 is formed at the middle of the first inner circumferential surface 37a in the lengthwise direction.

The raised section 39 includes inclined surfaces 39s. The inclined surfaces 39s are formed at both ends of the raised section 39 in the lengthwise direction. The inclined surfaces 39s are surfaces connecting the second inner circumferential surface 39a and the first inner circumferential surface 37a. The inclined surfaces 39s have such shapes that the protrusion amount of the raised section 39 gradually decreases as the distance from the middle side of the raised section 39 increases along the longer-side direction of the shaft 83.

A reason why such inclined surfaces 39s are provided is as follows. That is, in the present embodiment, the shaft 83 moves inside the shaft holding section 35 as mentioned above. If the inclined surfaces 39s are not provided, and there are steps at the ends of the raised section 39, there is a fear that the ends of the raised section 39 are caught by the grooves 83a of the shaft 83 (FIG. 14). In contrast, according to the present configuration, the ends of the raised section 39 are unlikely to be caught by the grooves 83a of the shaft 83, and it becomes possible to move the shaft 83 smoothly.

### Advantages of Shaft Holding Mechanism of Microphone Apparatus S1

According to the shaft holding mechanism of the microphone apparatus S1 like the one mentioned above, the raised section 39 protruding from the first inner circumferential surface 37a is provided at the shaft holding section 35 holding the shaft 83 of the microphone support member 81. As explained with reference to FIG. 13A and FIG. 13B, even if positional adjustments of the shaft 83 are repeated, and the raised section 39 wears, the area size of contact between the raised section 39 and the shaft 83 increases gradually. Accordingly, it is possible to prevent the sense of friction at the time of movement of the shaft 83 from lowering.

In addition, in the present embodiment, the raised section 39 protrudes in the same direction as the direction in which the fixation screws Sw are inserted. According to such a configuration, the shaft 83 is pressed against the raised section in a direction represented by the arrow B in FIG. 13. Accordingly, it becomes easier to attain the technical advantage of increasing the area size of contact between the shaft 83 and the raised section 39 as the raised section 39 wears, and maintaining the sense of friction.

Whereas a configuration in which the shaft 83 of the microphone support member 81 is movable in its extending direction is illustrated as an example of the shaft holding mechanism above, the shaft holding mechanism may be applied to a configuration in which the shaft 83 rotates about its central axis. The shaft need not necessarily be part of the microphone support member, but may be a portion provided to any component that needs to maintain a sense of friction. An inclined surface 39s of the raised section 39 need not be provided to each end, but may be provided only to one end.

Whereas the present disclosure has been explained using embodiments thus far, the technical scope of the present disclosure is not limited by the scope described in the embodiments described above, but various modifications and changes are possible within the scope of a gist of the present disclosure. For example, all or some of apparatuses can be configured functionally or physically distributed or integrated in any units. In addition, new embodiments that are generated by any combination of a plurality of embodiments are also included in embodiments of the present disclosure. Advantages of the new embodiments generated by the combination combine advantages of the original embodiments.

What is claimed is:

1. A shaft holding structure comprising:
a microphone support member that supports a microphone unit, and also has a rod-shaped shaft at part thereof; and
a holding member having formed therein a shaft holding section that holds the shaft in a state where the shaft is rotatable about a central axis of the shaft or the shaft is movable in an extending direction of the shaft, wherein
the shaft holding section has:
a peripheral wall that has a first inner circumferential surface formed in an arc-like shape as seen in a cross-section orthogonal to the extending direction of the shaft, and receives the shaft; and
a raised section forming a second inner circumferential surface that is formed to protrude from the first inner circumferential surface, and has a radius of curvature greater than a radius of curvature of the first inner circumferential surface, and
an outer circumferential surface of the shaft abuts on the second inner circumferential surface of the raised section in an assembled state where the shaft is received by the shaft holding section.

2. The shaft holding structure according to claim 1, wherein
the radius of curvature of the second inner circumferential surface is greater than both a radius of the shaft and the radius of curvature of the first inner circumferential surface.

3. The shaft holding structure according to claim 1, wherein
at one end or each of both ends of the raised section in a direction parallel to the extending direction of the shaft, the raised section has an inclined surface connecting the second inner circumferential surface and the first inner circumferential surface.

4. The shaft holding structure according to claim 1, wherein
the holding member has:
a base member having formed therein a receiving section that receives part of the shaft; and
a cover member that is a member having the shaft holding section formed therein, and is attached to the base member by a fixation member inserted in a thickness direction of the base member, and
the raised section protrudes in the same direction as a direction in which the fixation member is inserted.

5. The shaft holding structure according to claim 1, wherein
the holding member has:
a base member having formed therein a receiving section that receives part of the shaft; and
a cover member that is a member having the shaft holding section formed therein, and is attached to the base member, and
the receiving section has formed therein a guide rib that fits into a guide groove formed on the shaft along the extending direction of the shaft, and regulates a position of the shaft in the shaft holding section.

6. The shaft holding structure according to claim 5, wherein
both the guide groove and the guide rib are formed linearly.

7. The shaft holding structure according to claim 1, wherein
the raised section has, in a cross-section, a second center that is a center of a circle forming an arc of the raised section, the second center being positioned on a centerline passing through a first center that is a center of a circle forming an arc of the first inner circumferential surface, the second center being offset from the first center toward a side farther from the raised section.
